(19) United States
(12) Patent Application Publication
(10) Pub. No.: US 2009/0178114 A1
(43) Pub. Date: Jul. 9, 2009

(54) EDUCATIONAL LOG-ON METHOD

(76) Inventor: Aviva Susser, Birmingham, MI (US)

Correspondence Address: CARLSON, GASKEY & OLDS, P.C., 400 WEST MAPLE ROAD, SUITE 350, BIRMINGHAM, MI, 48009, US

(21) Appl. No.: 11/971,221

(22) Filed: Jan. 9, 2008

(51) Int. Cl. G06F 7/04

(52) U.S. Cl. 726/2

(57) ABSTRACT

An example method of accessing a computer includes receiving identification information from a user and receiving an answer to an educational query. The educational query is based on the identification information. The method limits access to a computer based on the answer, the time spend answering queries, or both.

### BACKGROUND OF THE INVENTION

This invention relates generally to educating a computer user before permitting the user to access a computer.

As known, computer settings can change based on log-on information provided by a user accessing the computer. Some computers require a log-on name and a correctly entered password before the user can access programs stored on the computer. The log-on name and password identify the user accessing the computer. As multiple users may access a single computer, many combinations of user names and passwords are used. Often, each user provides a unique user name and password when accessing computer programs within the computer.

Computers have many uses, including entertainment. For example, a child may access video games and other entertaining computer programs through the computer. Some computers, such as console-based video gaming systems, are designed purely for video games.

Parents sometimes wish to limit the access that their children would otherwise have to software programs or interactive activities through their computers. Parents also often desire that their child participate in educational activities, such as school homework. Accordingly, many parents closely monitor the amount of time their child spends on entertainment as opposed to more educational activities. As children typically enjoy playing video games, some parents reward their child with computer time to access the video games.

### SUMMARY OF THE INVENTION

An example method of accessing a computer includes receiving identification information from a user and receiving an answer to an educational query. The educational query is based on the identification information. The method limits access to a computer based on the answer.

Another example method of limiting access to a computer includes receiving identification information from a user and presenting an educational query based on the identification information. The method receives an answer to the educational query from the user and permits access to the computer based on the answer.

An example computer includes a display for communicating information to a user and at least one user profile associated with an educational query. A user input device receives input from the user and the user accesses recreational items through a computer after correctly answering the educational query associated with the user's user profile.

These and other features of the present invention can be best understood from the following specification and drawings. The following of which is a brief description.

### BRIEF DESCRIPTION OF THE DRAWINGS

FIG. 1 shows the flow of an example educational method for accessing a computer.

FIG. 2A shows a partial schematic representing a computer for executing the FIG. 1 method.

FIG. 2B shows a screen shot of the FIG. 2A computer during the log-on process.

FIG. 3A shows another example computer executing the FIG. 1 method.

FIG. 3B shows a screen shot of the FIG. 3A computer during the log-on process.

FIG. 4 schematically shows the flow of another example method for accessing a computer.

### DETAILED DESCRIPTION OF THE PREFERRED EMBODIMENT

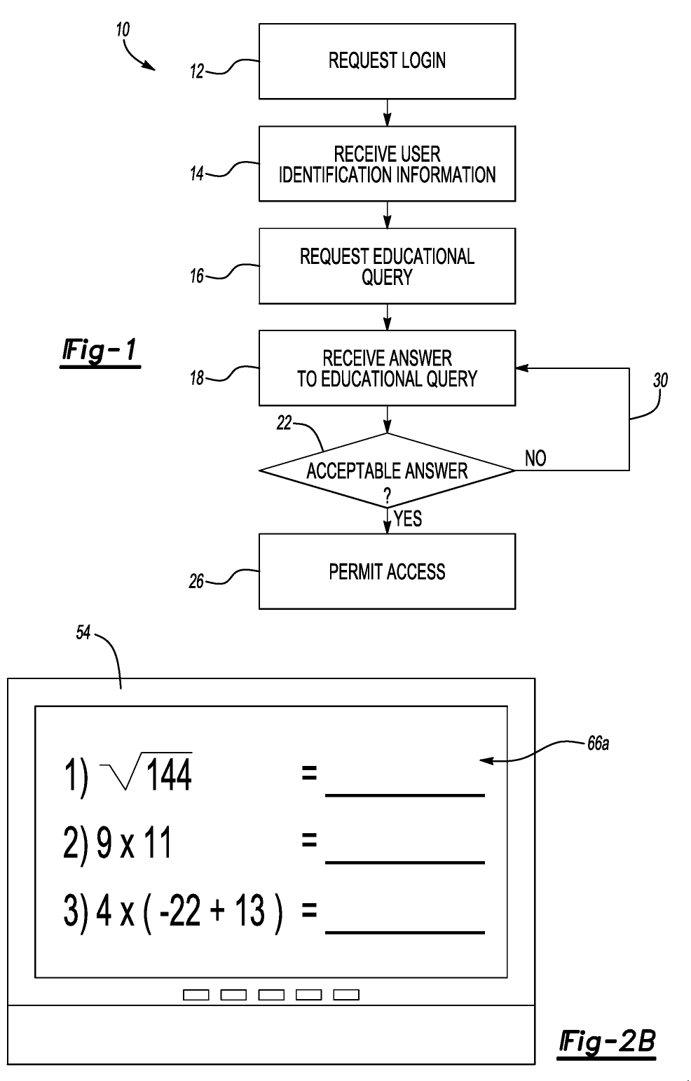

FIG. 1 shows an example educational method for accessing a computer 10. The method 10 requests log-on information in step 12, receives user identification information in step 14, and then presents an educational query in step 16. The method receives an answer in step 18 to the educational query of step 16. Access to the computer is permitted 26 or denied 30 in step 22 based on the answer in step 18.

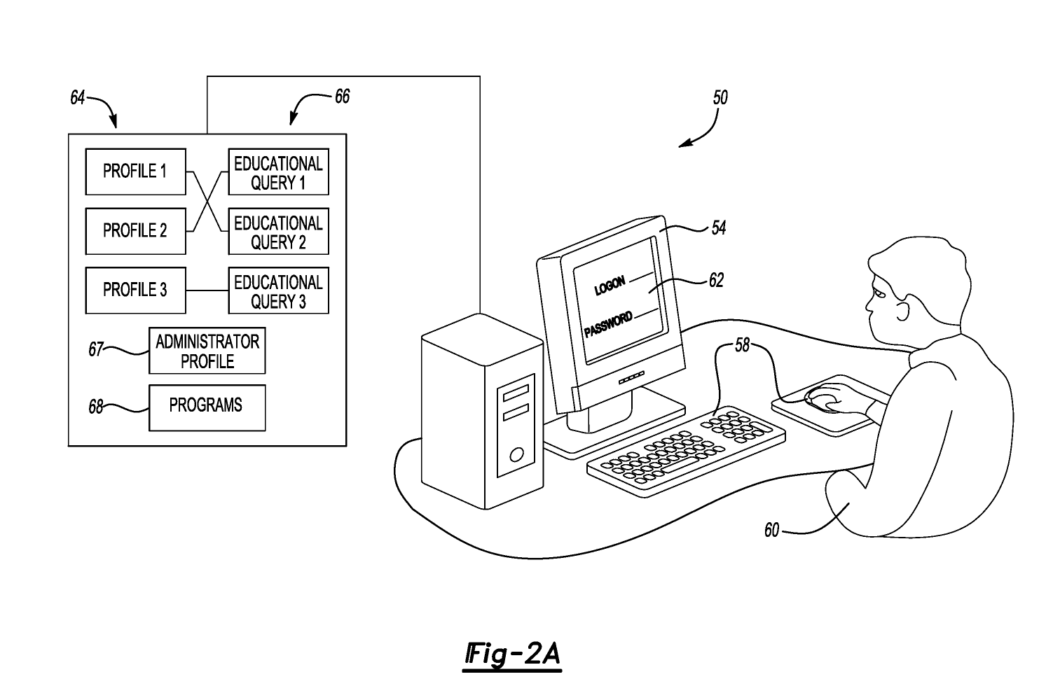

Referring now to FIGS. 2A-2B, in this example, a general purpose computer 50 executes the FIG. 1 method. The computer 50 includes a display 54 and various input devices 58, such as a keyboard and a mouse. A user 60 interacts with the input devices in a known manner to communicate information to the computer 50.

As schematically shown, the computer 50 includes a plurality of user profiles 64 associated with a plurality of educational queries 66. An administrator (not shown), such as a parent of the user 60, controls associations between one of the user profiles 64 and one of the educational queries 66. The administrator logs-on to the computer 50 using an administrator profile 67.

As is well-known, the computer 50 includes a processor and storage, such as memory, hard drives, or other optical, magnetic, or electronic storage for storing instructions which when executed by the processor perform the functions described.

The computer 50 also includes one or more programs 68. In this example, the user 60 is a child attempting to access the computer 50 to play a video game, one type of program 68. The display 54 shows a log-on 62 requiring input from the user 60 before permitting access. This log-on step is known and corresponds to receiving identification in step 14 of FIG. 1.

The log-on 62 helps the computer 50 identify the appropriate one of the user profiles 64 for the user 60. The computer 50 then displays the educational query 66 associated with that one of the user profiles 64. In some examples, accessing certain types of programs 68, like video games, requires the user 60 to answer the educational query 66. Accessing other types of programs 68, such as word processing programs, would not require answering the educational query 66.

In addition to video games, other example programs 68 requiring the user 60 to answer the education query 66 include a particular video game, a particular computer program, a portion of a wide area network (e.g., certain websites) or another type of interactive computer activity. The administrator may control which programs 68 require one of the educational queries 66 in addition to controlling the particular one of the educational queries 66 that is associated with each one of the user profiles 64. A person skilled in the art would learn how to associate appropriate educational queries 66 with the log-on 62 utilizing the administrator profile 67.

FIG. 2B shows a close up of the display 54 after receiving user identification information in 14 (FIG. 1). In this example, the display 54 of FIG. 2B corresponds to the step of presenting the educational query 18 in the FIG. 1 method.

As shown, the display 54 presents to the user 60 an educational query 66a requiring input from the user 60. In this example, the educational query 66a is a group of math problems, which are age appropriate for the user 60. The complexity of the educational query 66a is based on the particular user 60 accessing the computer 50.

Requiring the user 60 to answer the educational query 66a educates the user 60. As the user 60 is desirous of accessing the computer 50 to play video games, the user 60 answers the educational query 66a. Answering the educational query 66a may include entering an answer to the math problem using a keyboard, a type of user input device 58. Other examples may include selecting the answer from multiple presented answers, such as in multiple choice questions.

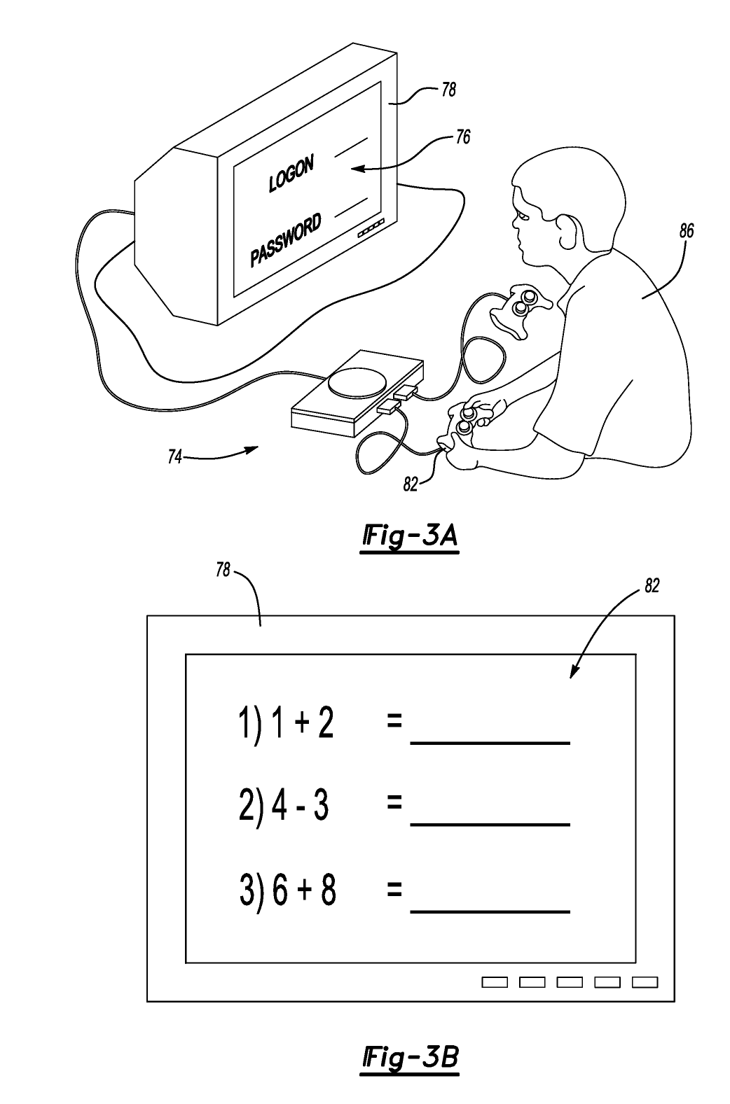

Referring to FIGS. 3A-3B, another example computer 74 includes a display 78 and a plurality of user input devices 82. In this example, the computer is a video gaming system specifically designed for video games, such as a Nintendo® or Xbox® gaming system. Thus, although described primarily in terms of a general purpose computer, those skilled in the art and having the benefit of this disclosure will understand that the example method 10 includes not only general purpose computers such as the computer 50 of FIGS. 2A-2B, but also other computer-based systems such as that shown in FIGS. 3A-3B.

A user 86 must enter identification information, such as a log-on 76, prior to accessing the computer 74 to play video games. After entering the log-on 76, the user 86 is required to enter the answer to one or more educational queries 82 as shown on the display 78. In FIG. 3B, the user 86 is younger, in a lower grade level, and less-educated than the user 60 of FIG. 2A. Accordingly, the educational queries 82 presented to the user 86 are simpler than the educational query 66a presented to the more-educated user 60. Using the log-ons 62 and 76, each of the computers 50 and 74 can select the appropriate one of educational queries 66 and 82 for the respective user 60 and 86.

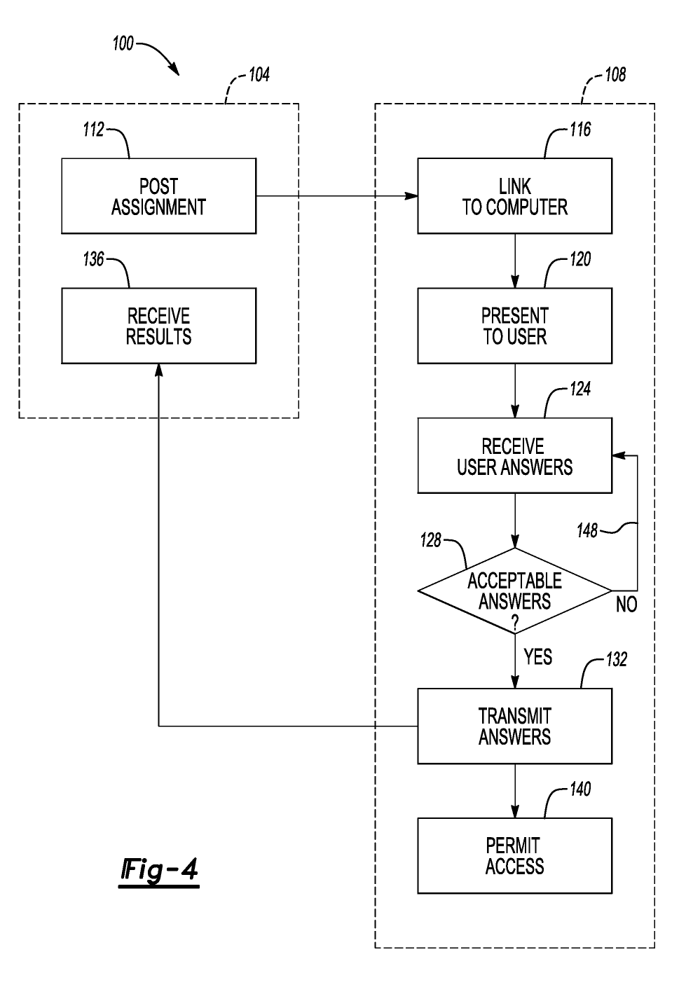

Referring now to FIG. 4, another example method 100 of accessing a computer includes using educational queries based on a homework assignment. In this example, the user attempting to access a computer attends a school 104 that prepares homework assignments 112 that are posted online. Once posted, the homework is accessible within a home 108. Such transmissions are known, and users often access information at home 108 that is transmitted from the user's school.

A computer at 116 within the home 108 connects to wide area network like the internet to present the posted homework assignment to the user at 120. In this example, the method 100 presents the homework assignment to the user before the user can access video games through the computer. The method 100 then receives user answers to the homework assignment at 124, and evaluates the answers at 128. If the answers are correct, the method 100 transmits the answers to the school at 132 and then permits the user to access the computer 140 to play video games, for example. The school 104 obtains the correct answers results at 136. In another example, the method 100 permits the user to access the computer 140 after achieving a certain percentage of correct answers, such as answering 80% of the questions on an assignment correctly. In yet another example, the method 100 permits the user to access the computer 140 after working on the homework assignment for a certain period of time, such as permitting the user to access the computer to play video games after working on a homework assignment for thirty minutes.

Still other examples may include receiving the user answers 124 at the school 104 rather than at the computer in the home 108. In this example, the evaluation at 128 takes place at the school 104 rather than the home 108 computer system. If the user answers the homework assignment incorrectly at 128, the method 100 requires further answers by returning the user to receive the user answer step at 148. In some examples, the user continues answering the homework assignment at 124 until answering correctly, which permits access to the computer at 140. In other examples, the user is locked out of the computer for some amount of time before permitted to supply user answers at 124. Other examples may just require turning in the homework assignment rather than checking answers.

While a preferred embodiment of this invention has been disclosed, a worker of ordinary skill in the art would recognize that certain modifications would come within the scope of this invention. For that reason, the following claims should be studied to determine the true scope and content of this invention.

I claim:

1. An educational method of accessing a computer, comprising:
(a) receiving identification information from a user;
(b) receiving an answer to an educational query, the educational query based on the identification information; and
(c) limiting access to a computer based on the answer.

2. The educational method of claim 1, wherein the educational query includes a homework assignment.

3. The educational method of claim 2, including receiving the homework assignment from an educational institution.

4. The educational method of claim 3, wherein the user attends the educational institution.

5. The educational method of claim 1, wherein the educational query is based upon at least one of a grade level of the user, an age of the user, and an education level of the user.

6. The educational method of claim 1, including preventing access to the computer if the answer is incorrect, and allowing access to the computer if the answer is correct.

7. The educational method of claim 6, including receiving another answer if the answer is incorrect.

8. The educational method of claim 1, wherein the computer is a general purpose computer.

9. A method of limiting access to a computer, comprising:
(a) receiving identification information from a user;
(b) presenting an educational query based on the identification information;
(c) receiving an answer to an educational query from the user; and
(d) permitting access to the computer based on the answer.

10. The method of claim 9, including preventing access to the computer if the answer is an incorrect answer.

11. The method of claim 9, wherein the computer is a general purpose computer or a console gaming system.

12. The educational method of claim 9, wherein the educational query includes a homework assignment.

13. The educational method of claim 12, including receiving the homework assignment from an educational institution.

14. The educational method of claim 13, wherein the user attends the educational institution.

15. The educational method of claim 9, wherein said step (d) comprises permitting access to the computer if the answer is a correct answer.

16. The educational method of claim 9, wherein said step (d) comprises permitting access to the computer if the answer is a certain percentage of individual correct answers.

17. The educational method of claim 9, wherein said step (d) comprises permitting access to the computer after presenting the educational query in said step (b) for an established period of time.

18. A computer, comprising:
a display for communicating information to a user;
at least one user profile;
at least one educational query associated with said at least one user profile; and
a user input device for receiving input from the user, wherein the user accesses recreational items through a computer after the user correctly answers the at least one educational query.

19. The computer of claim 18, wherein incorrectly answering the educational query prevents the user from accessing recreational items.

20. The computer of claim 18, wherein the computer includes a general purpose computer.

21. The computer of claim 18, wherein the computer includes a video game system.

22. A computer readable medium storing instructions which, when executed by a computer, performs the steps of:
(a) receiving identification information from a user;
(b) presenting an educational query based on the identification information;
(c) receiving an answer to an educational query from the user; and
(d) permitting access to the computer based on the answer.
